(19) United States
(12) Patent Application Publication
(10) Pub. No.: US 2017/0017325 A1
(43) Pub. Date: Jan. 19, 2017

(54) TOUCH DISPLAY DEVICE

(71) Applicant: Innolux Corporation, Miao-Li County (TW)

(72) Inventors: Chia-Hao Tsai, Miao-Li County (TW); Jen-Chieh Peng, Miao-Li County (TW); Chih-Hao Chang, Miao-Li County (TW); Bo-Feng Chen, Miao-Li County (TW); Tung-Kai Liu, Miao-Li County (TW)

(21) Appl. No.: 15/182,614

(22) Filed: Jun. 15, 2016

Related U.S. Application Data
(60) Provisional application No. 62/193,787, filed on Jul. 17, 2015.

(30) Foreign Application Priority Data
Mar. 4, 2016 (TW) 105106635

(51) Int. Cl. G06F 3/041; G09G 3/20

(52) U.S. Cl. CPC G06F 3/0412; G06F 3/0416; G09G 3/2092; G09G 2310/0297

(57) ABSTRACT

A touch display device comprising a touch display panel, a first de-multiplexer and a driving integrated circuit (IC) is provided. The touch display panel includes a plurality of first display data transmitting wires and a touch data transmitting wire. The first de-multiplexer includes a plurality of first output terminals and a first input terminal. The driving IC includes a multiplexer including a second output terminal. The first output terminals of the first de-multiplexer are electrically connected to the first display data transmitting wires and the touch data transmitting wire, respectively. The second output terminal of the multiplexer is electrically connected to the first input terminal of the first de-multiplexer through a first lead.

### CROSS-REFERENCE TO RELATED APPLICATION

This application claims the priority benefits of U.S. provisional application Ser. No. 62/193,787, filed on Jul. 17, 2015, and Taiwan application serial no. 105106635, filed on Mar. 4, 2016. The entirety of each of the above-mentioned patent applications is hereby incorporated by reference herein and made a part of this specification.

### BACKGROUND OF THE INVENTION

1. Field of the Invention

The invention relates to a touch display device, and more particularly, to a touch display device capable of reducing lead number of driving integrated circuit (IC) and peripheral region size of touch display panel.

2. Description of Related Art

Along with rapid development of electronic technology, consumer electronic products have become an indispensable part in people's daily life. In order to improve an operational convenience of the electronic products, high-performance touch display devices have become an essential type among the electronic products.

In the field of conventional technology, peripheral region of a touch display panel of a touch display device is usually disposed with a plurality of de-multiplexers for receiving display data signals outputted from a driving integrated circuit so as to reduce the number of leads (pins) required by the driving integrated circuit. However, in an integrated touch display device, the driving integrated circuit, in addition to provide the display data signals, also have to provide a certain number of touch signals. The touch signals, in the convention technology, still require a same number of leads for transmitting the touch signals into the touch display panel. As a result, when the number of the touch signals in the touch display device increases, the number of leads in the driving integrated circuit and the size of the peripheral region on the touch display panel will also increase in correspondence, thereby causing the production cost to increase.

### SUMMARY OF THE INVENTION

A touch display device which can effectively reduce the size of a driving integrated circuit and the size of a peripheral region of a touch display panel.

The touch display device includes a touch display panel, a first de-multiplexer and a driving integrated circuit. The touch display panel has a plurality of first display data transmitting wires and a touch data transmitting wire. The first de-multiplexer has a plurality of first output terminals and a first input terminal. The driving integrated circuit has a multiplexer, and the multiplexer has a second output terminal. The output terminals of the first de-multiplexer are electrically connected to the first display data transmitting wires and the touch data transmitting wire, respectively, and the second output terminal of the multiplexer is electrically connected to the first input terminal of the first de-multiplexer through a first lead.

In one embodiment, the multiplexer is capable of selecting an original first display data signal or an original touch signal as a selected signal, wherein, during a displaying time period, the multiplexer selects the original first display data signal as the selected signal and the first de-multiplexer transmits a first display data signal relative to the original first display data signal to one of the first display data transmitting wires, and during a touch detection time period, the multiplexer selects the original touch signal as the selected signal and the first de-multiplexer transmits a touch signal related to the original touch signal to the touch data transmitting wire.

In view of the above, in the touch display device, through configuring a plurality of multiplexers in the driving integrated circuit and by enabling the multiplexers to integrate transmission operations of the display data signal and the touch signal and to perform switching operations corresponding to the display data signal and the touch signal in cooperation with the de-multiplexer on the touch display panel, the driving integrated circuit can effectively reduce the number of output leads and a layout area required for the transmission wires, and thereby effectively lower the cost of the driving integrated circuit. Moreover, with the multiplexers in the driving integrated circuit, the numbers of leads, connecting wires and bonding pads between the driving integrated circuit and the touch display panel may also be reduced, thereby reducing the area required by the peripheral region of the touch display panel and the overall production cost.

In order to make the aforementioned and other features and advantages comprehensible, several exemplary embodiments accompanied with figures are described in detail below

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a touch display device according to an embodiment of the invention.

FIG. 2 is a schematic diagram illustrating a touch display device according to another embodiment of the invention.

FIG. 3A to FIG. 3E are schematic diagrams illustrating actuation an operation mode of a de-multiplexer DEMUX1 and a multiplexer MUX1 according to an embodiment of the invention.

FIG. 4 is a schematic diagram illustrating a touch display device according to yet another embodiment of the invention.

FIG. 5 is a schematic diagram illustrating the configuration of a plurality of touch detection units according to an embodiment of the invention.

### DESCRIPTION OF THE EMBODIMENTS

Referring to FIG. 1, FIG. 1 is a schematic diagram illustrating a touch display device 100 according to an embodiment of the invention. The touch display device 100 includes a touch display panel 110, a plurality of de-multiplexers DEMUX1˜DEMUXN and a driving integrated circuit 120. The driving integrated circuit 120 includes a plurality of multiplexers MUX1˜MUXN. In one embodiment, the de-multiplexers DEMUX1˜DEMUXN are disposed on a peripheral region 112 of the touch display panel 110, and a plurality of output terminals of the de-multiplexers DEMUX1˜DEMUXN may be electrically connected to a plurality of display data transmitting wires D11˜D13, D21˜D23, . . . DN1˜DN3 and a plurality of touch data transmitting wires T11˜TN1 on the touch display panel 110, respectively. Using the de-multiplexer DEMUX1 as an example, the output terminals of the de-multiplexer DEMUX1 are electrically connected to the display data transmitting wires D11˜D13 and the touch data transmitting wire T11, wherein the display data transmitting wires D11˜D13 can be respectively used to transmit display data signals of different gray-scale voltages or currents to a plurality of sub-pixel columns in the touch display region 111, while the touch data transmitting wire T11 can be used to transmit a touch signal to a touch detection unit in the touch display region 111. In other embodiments, the number of the touch data transmitting wire may be greater than 1, and smaller than or equal to the number of the display data transmitting wires. In other embodiments, the de-multiplexers DEMUX1˜DEMUXN may be disposed in the driving integrated circuit 120 rather than on the peripheral region 112 of the touch display panel 110.

When the touch signal includes a touch driving signal and a touch sensing signal, and the touch detection unit is a capacitive sensing type touch detection unit, then the touch display panel 110 is a self-capacitance touch display panel. When the touch signal only includes one of the touch driving signal and the touch sensing signal and, the touch detection unit is the capacitive sensing type touch detection unit, the touch display panel 110 is a mutual capacitance touch display panel.

On the other hand, the de-multiplexers DEMUX1˜DEMUXN are respectively corresponded to the multiplexers MUX1˜MUXN in the driving integrated circuit 120.

Input terminals of the de-multiplexers DEMUX1˜DEMUXN are electrically connected to output terminals of the multiplexers MUX1˜MUXN, respectively, through leads LD1˜LDN. Moreover, input terminals of the multiplexers MUX1˜MUXN respectively receive original display data signals DIN1˜DINN and original touch signals TS1˜TSN, and each of the multiplexers MUX1˜MUXN can select one of the original display data signal DIN1 . . . or D1NN and the original touch signal TS1 . . . or TSN received thereby to be transmitted to the input terminal of the corresponding de-multiplexer DEMUX1 . . . or DEMUXN through the corresponding lead LD1 . . . or LDN. Using the multiplexer MUX1 as an example, the multiplexer MUX1 selects the original display data signal DIN1 or the original touch signal TS1 as the selected signal and then transmits the selected signal to the input terminal of the corresponding de-multiplexer DEMUX1 through the lead LD1. The original display data signal at the input terminal of the multiplexer, the display data signal at the output terminal of the de-multiplexer and the intermediate display data signal being transmitted in the lead are interrelated but can be varied in amplitude, frequency and size after being modulated by various elements. Similarly, the original touch signal at the input terminal of the multiplexer, the touch signal at the output terminal of the de-multiplexer output terminal and the intermediate touch signal being transmitted in the lead are interrelated but can be varied in amplitude, frequency and size after being modulated by various elements.

Further, there is certain corresponding relationship between operations of the multiplexers MUX1˜MUXN and the de-multiplexers DEMUX1˜DEMUXN. Again, using the multiplexer MUX1 and the de-multiplexer DEMUX1 as an example, when the multiplexer MUX1 selects the original touch signal TS1 as the selected signal, the corresponding de-multiplexer DEMUX1 transmits a touch signal related to the selected original touch signal TS1 to the touch data transmitting wire TS1. Relatively, when the multiplexer MUX1 selects the original display data signal DIN1 as the selected signal, the corresponding de-multiplexer DEMUX1 transmits a display data signal related to the selected original display data signal DIN1 to one of the display data transmitting wires D11˜D13. In other embodiments, when the multiplexer MUX1 selects the original touch signal TS1 as the selected signal, the corresponding de-multiplexer DEMUX1 can simultaneously transmit a touch signal related to the selected original touch signal TS1 to the touch data transmitting wire TS1 and the display data transmitting wires D11˜D13, so as to lower the loading.

In terms of operation details, when the touch display device 100 executes touch and display operations, the, touch display device 100 can enter a displaying time period, and in the displaying time period, the multiplexers MUX1˜MUXN can respectively select the original display data signals DIN1˜DINN as the selected signals and respectively transmit intermediate display data signals related to the selected signals to the input terminals of the corresponding de-multiplexers DEMUX1˜DEMUXN through the lead LD1˜LDN, and then the output terminals of the de-multiplexers DEMUX1˜.DEMUXN can transmit the display data signals to the display data transmitting wires D11˜DN3. It is worth mentioning that, the displaying time period may further be divided into a plurality of sub-time periods, wherein, during a first sub-time period, the de-multiplexers DEMUX1˜DEMUXN may respectively transmit the display data signals related to the selected signals to a first group of display data transmitting wires D11˜DN1 and their sub-pixel columns; next, during a second sub-time period, the de-multiplexers DEMUX1˜DEMUXN may respectively transmit the display data signals related to the selected signals to a second group of display data transmitting wires D12˜DN2 and their sub-pixel columns; and, during a third sub-time period, the de-multiplexers DEMUX1˜DEMUXN may respectively transmit the display data signals related to the selected signals to a third group of display data transmitting wires D13˜DN3 and their sub-pixel columns. If a touch display region 111 of the touch display panel 110 has m row of display pixels (m is a value including 0 and positive integer), then the first group of display data transmitting wires D11˜DN1 is connected to (m/3)+1^{th} sub-pixel column, the second group of display data transmitting wires D12˜DN2 is connected to (m/3)+2^{th} sub-pixel column, and the third group of display data transmitting wires D13˜DN3 is connected to m/3^{th} sub-pixel column. The (m/3)+1^{th} sub-pixel column, the (m/3)+2^{th} sub-pixel column and the m/3^{th} sub-pixel column can respectively be corresponded to a red (R), green (G) or blue (B) color filter, or the (m/3)+1^{th} sub-pixel column, the (m/3)+2^{th} sub-pixel column and the m/3^{th} sub-pixel column can respectively be a red (R), green (G) or blue (B) light-emitting unit, such as an organic (OLED) or non-organic light-emitting diode (LED).

After the displaying time period is ended, the touch display device 100 can enter a touch detection time period. During the touch detection time period, the multiplexers MUX1˜MUXN can respectively select the original touch signals TS1˜TSN as the selected signals and respectively transmit the intermediate touch signals related to the selected signals to the input terminals of the corresponding de-multiplexers DEMUX1˜DEMUXN through the lead LD1˜LDN, and then the output terminals of the de-multiplexers DEMUX1˜DEMUXN can transmit the touch signals to the touch data transmitting wires T11˜TN3. The displaying time period and the touch detection time period substantially do not overlap (separated).

It can be known from the above descriptions, in the touch display device 100 of one embodiment of the invention, by configuring the multiplexers MUX1˜MUXN in the driving integrated circuit 120, the original touch signals TS1˜TSN can be respectively integrated with the original display data signals DIN1˜DINN within the driving integrated circuit 120, so that the touch signals or the display data signals can be transmitted to the touch display panel 110 during an appropriate time period so as to execute a screen display or touch detection operation. As a result, the driving integrated circuit 120 does not have to provide excess leads (pins) for transmitting the touch signals TS1˜TSN, and the numbers of transmission wires and bonding pads between the driving integrated circuit 120 and the touch display panel 110 are also not increased. Therefore, the size of the driving integrated circuit 120 and the size of the peripheral region 112 of the touch display panel 110 can be effectively controlled.

Additionally mentioning that, in one embodiment, the touch display panel 110 can be an on-cell touch display panel or may also be an in-cell touch display panel. The de-multiplexers DEMUX1˜DEMUXN can be disposed on a back plate of the touch display panel 110, and the de-multiplexers DEMUX1˜DEMUXN may share a same manufacturing process with a thin film transistor (TFT), whereby an active layer of the thin film transistor can be made of low temperature poly-silicon (LTPS), a metal oxide semiconductor (IGZO) or amorphous silicon (a-Si).

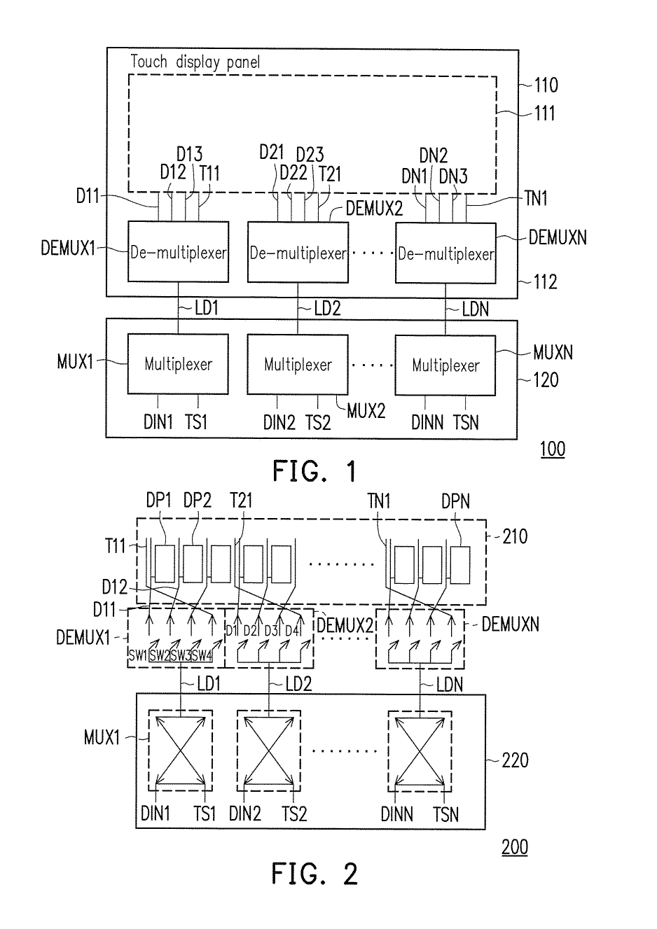

Referring to FIG. 2, FIG. 2 is a schematic diagram illustrating a touch display device 200 according to another embodiment of the invention. The touch display device 20 includes a plurality of de-multiplexers DEMUX1˜DEMUXN, and the de-multiplexers DEMUX1˜DEMUXN can be located on a peripheral region of a touch display panel of the touch display device 200 or may also be integrated within a driving integrated circuit 220. Using the de-multiplexer DEMUX1 as an example, output terminals of the de-multiplexer DEMUX1 are electrically connected to a plurality of display data transmitting wires D11, D12, D13 and a touch data transmitting wire T11, respectively. The display data transmitting wires D11, D12, D13 are electrically connected to a plurality of display pixels DP1˜DP3 in a touch display region 211, respectively, wherein the display pixels DP1˜DPN may respectively display the same or different gray-scale, or images of different color. The touch data transmitting wire T11 is electrically connected to the touch detection unit in the touch display panel. In one embodiment, the touch detection unit can be shared with a common electrode of the display pixels DP1˜DP3; whereas, in other embodiments, the touch detection unit can be an independent patterned electrode unit. In one embodiment, the de-multiplexer DEMUX1 includes a plurality of switch devices SW1˜SW4, wherein terminals of the switch device SW1˜SW4 at one side are all electrically connected to the driving integrated circuit 220 through the lead LD1, and terminals of the switch device SW1˜SW4 at the other side are electrically connected to the display data transmitting wires D11, D12, D13 and the touch data transmitting wire T11, respectively.

The driving integrated circuit 220 has a plurality of leads LD1˜LDN, and the leads LD1˜LDN are electrically connected to the input terminals of the de-multiplexers DEMUX1˜DEMUXN, respectively. Moreover, the driving integrated circuit 220 includes a plurality of multiplexers MUX1˜MUXN, and output terminals of the multiplexers MUX1˜MUXN are electrically connected to the leads LD1˜LDN, respectively. Each of the multiplexers MUX1˜MUXN can be a selector which can select one signal among a plurality of signals. Using the multiplexer MUX1 as an example, the multiplexer MUX1 selects an original display data signal DIN1 or an original touch signal TS1 as a selected signal and transmits an intermediate display data signal or an intermediate touch signal related to the selected signal to the input terminal of the de-multiplexer DEMUX1 through the lead LD1.

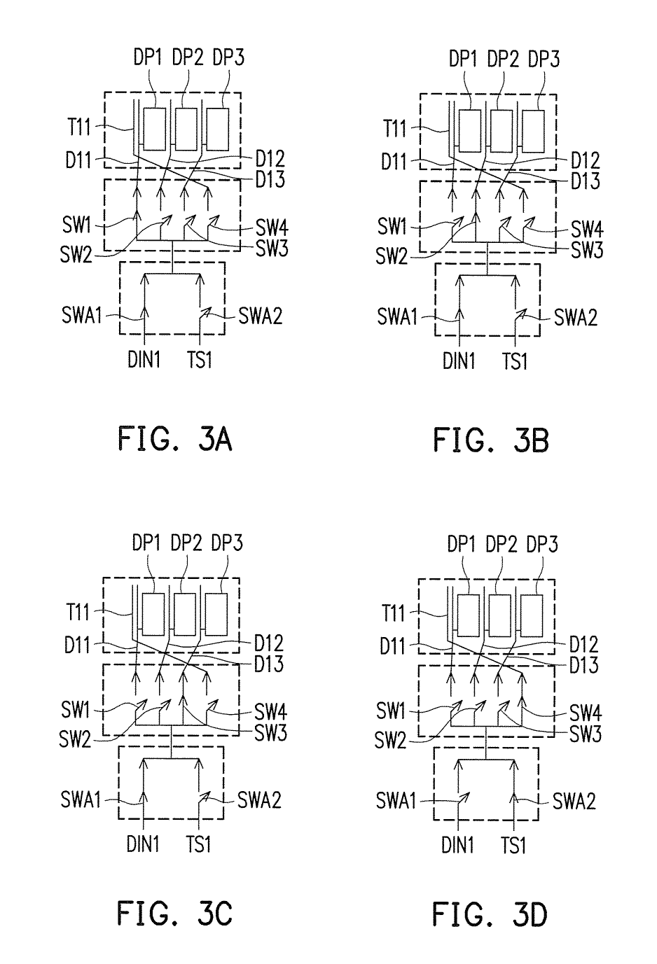

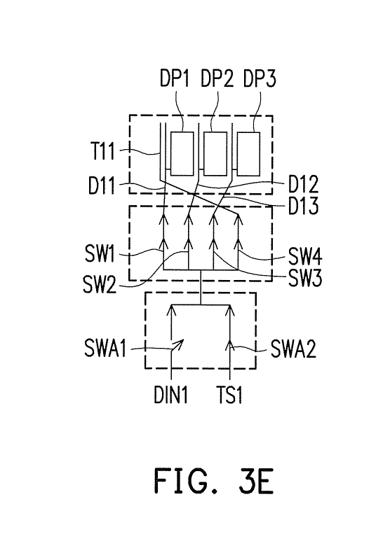

Operation details regarding the de-multiplexers DEMUX1˜DEMUXN and the multiplexers MUX1˜MUXN can be referred to the schematic diagrams shown in FIG. 3A to FIG. 3E, in which operation modes of the de-multiplexer DEMUX1 and the multiplexer MUX1 are illustrated according to embodiments of the invention. In the embodiments of FIG. 3A to FIG. 3E, the de-multiplexer DEMUX1 is constituted by the switch devices SW1˜SW4. The multiplexer MUX1 is constituted by the switch devices SWA1 and SWA2. First terminals of the switch devices SWA1 and SWA2 are both electrically connected to the input terminal of the corresponding de-multiplexer DEMUX1 and provide the intermediate display data signal or the intermediate touch signal related to the selected signal, and second terminals of the switch devices SWA1 and SWA2 respectively receive the original display data signal DIN1 and the original touch signal TS1.

Regarding operation details, in FIG. 3A, during the displaying time period, the switch device SWA1 is turned on while the switch device SWA2 is turned off, and the multiplexer MUX1 selects the original display data signal DIN1 as the selected signal and transmits the intermediate display data signal related to the original display data signal DIN1 to the input terminal of the de-multiplexer DEMUX1 through the lead LD1.

During the first sub-time period of the displaying time period, the switch device SW1 is turned on while the switch devices SW2˜SW4 are all turned off Therefore, the de-multiplexer DEMUX1 transmits a display data signal related to the original display data signal DIN1 and the intermediate display data signal to the display data transmitting wire D11. Through the display data transmitting wire D11, the display data signal can be transmitted to the display pixel DP1.

Next, in FIG. 3B, during the second sub-time period of the displaying time period, the switch devices SW1, SW3, SW4 are turned off while the switch device SW2 is turned on. At this moment, the de-multiplexer DEMUX1 transmits the display data signal related to the original display data signal DIN1 to the display data transmitting wire D12. Through the display data transmitting wire D12, the display data signal can be transmitted to the display pixel DP2.

Further, in FIG. 3C, during the third sub-time period of the displaying time period, the switch devices SW1, SW2, SW4 are turned off while the switch device SW3 is turned on. At this moment, the de-multiplexer DEMUX1 transmits the display data signal related to the original display data signal DIN1 to the display data transmitting wire D13. Through the display data transmitting wire D13, the display data signal can be transmitted to the display pixel DP3.

In FIG. 3D, the displaying time period is ended and enters into the touch detection time period. Now, the switch device SWA2 is turned on and the switch device SWA1 is turned off, and the multiplexer MUX1 selects the original touch signal TS1 as the selected signal and transmits the intermediate touch signal related to the touch signal TS1 to the input terminal of the de-multiplexer DEMUX1 through the lead LD1. In the de-multiplexer DEMUX1, the switch devices SW1˜SW3 are turned off while the switch device SW4 is turned on. Therefore, the touch signal related to the original touch signal TS1 and the intermediate touch signal is transmitted to the touch data transmitting wire T11. The touch signal can be transmitted to the touch detection unit through the touch data transmitting wire T11.

In addition, in order to reduce the loading of signal transmission, another driving method may also be adopted during the touch detection time period; in FIG. 3E, the multiplexer MUX1 selects the original touch signal TS1 as the selected signal and transmits the intermediate touch signal related to the original touch signal TS1 to the input terminal of the de-multiplexer DEMUX1, the switch devices SW1˜SW4 of the de-multiplexer DEMUX1 are all turned on, and the touch signal is transmitted to the touch detection unit and the display pixels DP1˜DP3 through the touch data transmitting wire T11.

It is worth mentioning that, in FIG. 3A to FIG. 3E, the touch data transmitting wire T11 and the display data transmitting wires D11˜D13 can be disposed at different layers, so that a risk of short-circuiting between the touch data transmitting wire T11 and anyone of the display data transmitting wires D11˜D13 can be avoided. In addition, the display pixels DP1˜DPN can display various images with different grey-scale and color.

Moreover, the switch devices SW1˜SW4 can be constructed with the thin film transistors, and the switch devices SWA1 and SWA2 can be constructed with the semiconductor elements, such as transistor switches, in the integrated circuit. The de-multiplexer DEMUX1 being disposed with four switch devices SW1˜SW4 is only provided as an example, such that the number of the switch devices in the de-multiplexer DEMUX1 can be configured according to actual requirement and is not being limited.

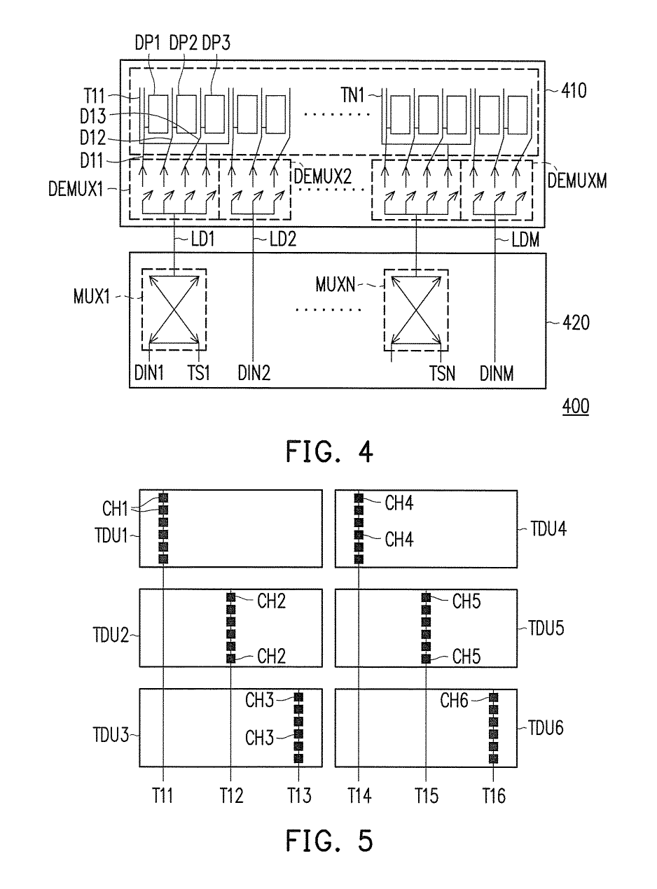

Referring to FIG. 4, FIG. 4 is a schematic diagram illustrating a touch display device 400 according to yet another embodiment of the invention. The touch display device 400 includes a touch display panel 410, a plurality of de-multiplexers DEMUX1˜DEMUXM and a driving integrated circuit 420. The driving integrated circuit 420 includes a plurality of multiplexers MUX1˜MUXN and has a plurality of leads LD1˜LDM.

Each of the leads LD1˜LDM can be electrically connected to the output terminal of one of the multiplexers MUX1˜MUXN or can directly receive a signal source of an original display data signal (e.g., a display data signal DIN2).

In one embodiment, the number of the multiplexers MUX1˜MUXN can be less than the number of the de-multiplexers DEMUX1˜DEMUXM, that is, the value of M is greater than the value of N, and the multiplexers MUX1˜MUXN are also not corresponded to the de-multiplexers DEMUX1˜DEMUXM in a one-by-one manner.

Moreover, not all the de-multiplexers DEMUX1˜DEMUXM have the same interior structure. The de-multiplexer (e.g., DEMUX1) corresponding to one of the multiplexers MUX1˜MUXN has four switch devices such that the de-multiplexer (e.g., DEMUX1), in addition to connecting with the display data transmitting wires (e.g., D11˜D13), is also electrically connected to the touch data transmitting wire T11 or TN2. The de-multiplexer (e.g., DEMUX2) not corresponding to the multiplexers MUX1˜MUXN has three switch devices such that the de-multiplexer (e.g., DEMUX2) is not electrically connected to the touch data transmitting wire T11 or TN1 but only connected to the display data transmitting wires (e.g., D11˜D13). 100361 When the number of the display pixels DP1˜DP3 in the touch display panel is far greater than the number of the touch detection unit, then the number of the touch data transmitting wire T11 or TN1 in the touch display panel 410 is also far less than the number of the display data transmitting wires. Therefore, the number of the multiplexers MUX1˜MUXN in the driving integrated circuit 420 may also be configured according to the number of the touch data transmitting wire T11 or TN1 required by the actual requirements, instead of configuring a corresponding multiplexer for each of the output leads LD1˜LDM. Correspondingly, interior structures of the de-multiplexers DEMUX1˜DEMUXM may also be adjusted according to the configurations of the multiplexers MUX1˜MUXN.

Referring to FIG. 5, FIG. 5 is a schematic diagram illustrating the configuration of a plurality of touch detection units according to an embodiment of the invention. The touch display panel can be disposed with a plurality of touch detection units TDU1˜TDU6 therein. The touch data transmitting wires T11˜T16 can be electrically connected to the touch detection units TDU1˜TDU6, respectively. The touch data transmitting wires T11˜T16 can be electrically connected to the touch detection units TDU1˜TDU6, respectively, through a plurality of contact holes CH1˜CH6.

In summary, through configuring a plurality of multiplexers in the driving integrated circuit and by cooperating with the operations of the de-multiplexers in the display panel, can effectively integrate the signal transmission operations of the display data signals and the touch signals between the driving integrated circuit and the touch display panel, so as to reduce the number of the signal transmission leads required by the driving integrated circuit and to reduce an area of the peripheral region on the touch display panel that is used for accommodating the signal transmitting wires, thereby effectively lowering the production cost.

It will be apparent to those skilled in the art that various modifications and variations can be made to the structure without departing from the scope or spirit of the invention. In view of the foregoing, it is intended that the invention cover modifications and variations of this invention provided they fall within the scope of the following claims and their equivalents.

What is claimed is:

1. A touch display device, comprising:
a touch display panel, having a plurality of first display data transmitting wires and a touch data transmitting wire;
a first de-multiplexer, having a plurality of first output terminals and a first input terminal; and
a driving integrated circuit, having a multiplexer, the multiplexer having a second output terminal connected to a first lead,
wherein the first output terminals of the first de-multiplexer are electrically connected to the first display data transmitting wires and the touch data transmitting wire, and the second output terminal of the multiplexer is electrically connected to the first input terminal of the first de-multiplexer through the first lead.

2. The touch display device as recited in claim 1, wherein the multiplexer is capable of selecting an original first display data signal or an original touch signal as a selected signal, wherein the multiplexer selects the original first display data signal as the selected signal and the first de-multiplexer transmits a first display data signal related to the original first display data signal to one of the first display data transmitting wires during a displaying time period, and wherein the multiplexer selects the original touch signal as the selected signal and the first de-multiplexer transmits a touch signal related to the original touch signal to the touch data transmitting wire during a touch detection time period.

3. The touch display device as recited in claim 2, wherein the multiplexer selects the original touch signal as the selected signal and the first de-multiplexer transmits the touch signal related to the original touch signal to the touch data transmitting wire and the first display data transmitting wires during the touch detection time period.

4. The touch display device as recited in claim 2, wherein the displaying time period and the touch detection time period substantially do not overlap.

5. The touch display device as recited in claim 1, wherein the first de-multiplexer comprises:
a plurality of first switch devices, wherein first terminals of the first switch devices are electrically connected to the first input terminal of the first de-multiplexer, and second terminals of the first switch devices are electrically connected to the first display data transmitting wires and the touch data transmitting wire through the first output terminals.

6. The touch display device as recited in claim 5, wherein the first switch devices electrically connected to the first display data transmitting wires are respectively turned on while the first switch devices electrically connected to the touch data transmitting wire are turned off during the displaying time period, and wherein the first switch devices electrically connected to the first display data transmitting wires are turned off while the first switch devices electrically connected to the touch data transmitting wire are turned on during the touch detection time period.

7. The touch display device as recited in claim 5, wherein the first switch devices electrically connected to the first display data transmitting wires are respectively turned on while the first switch devices electrically connected to the touch data transmitting wire are turned off, and during the touch detection time period, the first switch devices are all turned on during the displaying time period.

8. The touch display device as recited in claim 1, wherein the multiplexer comprises:
a second switch devices, capable of receiving the original first display data signal; and
a third switch devices, capable of receiving the original touch signal.

9. The touch display device as recited in claim 1, further comprising a second de-multiplexer, the second de-multiplexer having a plurality of third output terminals and a third input terminal,
wherein the third output terminals of the second de-multiplexer are electrically connected to the second display data transmitting wires, respectively, and the driving integrated circuit is electrically connected to the third input terminal of the second de-multiplexer through a second lead.

10. The touch display device as recited in claim 9, wherein the first display data transmitting wires and the second display data transmitting wires are electrically connected to a plurality of display pixels on the touch display panel, respectively, and the touch data transmitting wire is electrically connected to a touch detection unit in the touch display panel.
